(19) United States
(12) Patent Application Publication
(10) Pub. No.: US 2019/0084273 A1
(43) Pub. Date: Mar. 21, 2019

(54) SEMIFINISHED PART AND METHOD FOR PRODUCING A VEHICLE COMPONENT, USE OF A SEMIFINISHED PART, AND VEHICLE COMPONENT

(71) Applicants: THYSSENKRUPP STEEL EUROPE AG, Duisburg (DE); thyssenkrupp AG, Essen (DE)

(72) Inventors: David PIERONEK, Dortmund (DE); Harald HOFMANN, Dortmund (DE)

(73) Assignees: THYSSENKRUPP STEEL EUROPE AG, Duisburg (DE); thyssenkrupp AG, Essen (DE)

(21) Appl. No.: 15/760,904

(22) PCT Filed: Sep. 6, 2016
(86) PCT No.: PCT/EP2016/070928

§ 371 Date: Mar. 16, 2018

(30) Foreign Application Priority Data
Sep. 24, 2015 (DE) 10 2015 116 186.9

(51) Int. Cl. B32B 15/01; B32B 37/18; C22C 38/32; C22C 38/28; C22C 38/22; C22C 38/06; C22C 38/04; C22C 38/02; C22C 38/00; C22C 38/24; C22C 38/26; B62D 25/04; B62D 29/00; B62D 21/00

(52) U.S. Cl. CPC B32B 15/011; B32B 2307/72; C22C 38/32; C22C 38/28; C22C 38/22; C22C 38/06; C22C 38/04; C22C 38/02; C22C 38/002; C22C 38/24; C22C 38/26; B62D 25/04; B62D 29/007; B62D 21/00; B32B 2605/00; B32B 37/18

(57) ABSTRACT

A semifinished product for production of a vehicle component may include a first steel material and a second steel material. The steel materials may be bonded to one another in a form-fitting, force-fitting and/or cohesive manner. The first steel material may have a lower mass density and the second steel material may have a higher mass density. In particular, a ratio of the lower mass density of the first steel material to the higher mass density of the second steel material is at most 0.95. The lower mass density of the first steel material may be less than 7.5 g/cm³.

The present invention relates to a semifinished product for production of a vehicle component, comprising a first steel material and at least one second steel material, wherein the steel materials have been bonded to one another in a form-fitting, force-fitting and/or cohesive manner. The invention additionally relates to a process for producing a vehicle component, to a use of a semifinished product of the invention and to a vehicle component.

A particular aim in automobile construction is that of reducing the vehicle weight. This can firstly achieve a reduction in emissions and secondly also an increase in range, which is desirable particularly in the case of electric cars. This can be achieved, for example, by substituting the existing materials for lighter materials. However, this course of action can meet technical limits in numerous vehicle components, since this can also affect the strength and stiffness of the corresponding component. However, necessary strength and stiffness demands in particular have to be kept in mind here for safety reasons and must be complied with.

There are different approaches in the prior art to reconciling the opposing demands of a low weight on the one hand and a high strength or stiffness on the other hand.

For example, the document EP 2 228 459 A1 discloses a process which describes a process for producing a component for a vehicle. The component here consists of a first blank made from a press-hardenable steel and a second blank made from a high-manganese steel. This provides a component having elevated elongation at break with the same high strength. However, the components thus produced are still in need of improvement, especially in relation to a low weight.

Documents EP 2 767 602 A1 and EP 2 767 601 A1 propose, for further reduction in weight with optimized mechanical properties, providing a flat steel product consisting of an iron-aluminum base alloy. This can achieve a lower weight. However, it is necessary here in turn to accept compromises with regard to costs, formability, strength and/or ductility.

Moreover, it should be taken into account that an increase in strength alone is frequently insufficient when a geometric modification and hence extra weight is involved for the required stiffness.

Against this background, it is an object of the invention to specify a semifinished product for production of a vehicle component, a process for producing a vehicle component, a use of a semifinished product of the invention and a vehicle component, wherein the properties that are known from steel materials used to date are to be maintained as far as possible or even improved, even with a lower weight of the vehicle component.

In a first teaching of the present invention, the object is achieved in that the first steel material has a lower mass density and the second steel material a higher mass density and the ratio of the lower mass density of the first steel material to the higher mass density of the second steel material is not more than 0.95.

The semifinished product of the invention makes use of the fact that the first steel material having the lower mass density can reduce the weight of the semifinished product and of the vehicle component produced therefrom. At the same time, however, the second steel material can very substantially maintain the advantageous properties of the vehicle component. As a result, the compromises that would be necessary if, for example, the entire vehicle component consisted of the first steel material can be reduced or even entirely avoided. More particularly, it has been found that a steel material of this kind or a combination of steel materials of this kind is suitable for use in semifinished products for production of vehicle components. To give an example, it has been found that, for instance, in the production of a vehicle component in the form of a B pillar, it is possible to save up to 10% of the total B pillar weight, while the other properties can be very substantially maintained.

A first steel material having a lower mass density is understood to mean that the mass density of the first steel material is lower compared to the mass density of the second steel material. Correspondingly, a second steel material having a higher mass density is understood to mean that the mass density of the second steel material is higher compared to the mass density of the first steel material.

The fact that the ratio of the lower mass density of the first steel material to the higher mass density of the second steel material is not more than 0.95 means that the first steel material has 95% or less of the density of the second steel material. In this respect, the first steel material can be regarded as a density-reduced steel material. More preferably, the ratio of the lower mass density of the first steel material to the higher mass density of the second steel material is not more than 0.90. In this way, it is possible to achieve a particularly effective reduction in weight. Preferably, the ratio of the mass densities, however, is at least 0.70, preferably 0.80.

The (at least) second steel material is, for example, a dual-phase steel, a multiphase steel, a complex phase steel, a residual austenite steel, a martensite phase steel, a higher-strength IF steel, a higher-strength stretch-drawing steel, a deep-drawing steel, a bake-hardening steel, a phosphorus-alloyed steel, a microalloyed higher-strength steel, a spring steel or a quenched and tempered steel, preferably a manganese-boron steel. The first and/or second steel material may, for example, have been cold- or hot-rolled. The first and/or second steel material may, for example, be a cold- or hot-formable steel.

Preferably, the (at least) second steel material is a steel (especially a manganese-boron steel, a dual-phase steel, a complex phase steel or a multiphase steel) having a tensile strength Rₘ of at least 400 MPa, preferably at least 700 MPa, further preferably at least 900 MPa, especially preferably at least 1000 MPa, in the use state. Likewise preferably, the (at least) second steel material may be a deep-drawing steel having a lower tensile strength but higher elongation at break A₈₀, for example at least 20%, preferably at least 30%.

The semifinished product may additionally have an at least partial surface coating, for instance an organic or inorganic surface coating.

The first and the (at least) second steel material are preferably bonded directly to one another. In the bonding of the first and the (at least) second steel material, a cohesive bond is especially preferred. The cohesive bond may be established, for example, by rolling, especially hot rolling, casting, welding, soldering, plating and/or adhesive bonding.

The semifinished product may likewise also comprise further steel materials or other materials. In that case, the further materials may likewise have been bonded to the first and/or second steel material in order to form the semifinished product. However, the semifinished product preferably consists exclusively of the first and second steel materials.

The fact that the semifinished product is a semifinished product for production vehicle component means more particularly that the semifinished product is in such a form that the dimensions, for instance the thickness or size of the semifinished product, are also designed correspondingly in order to be able to produce a vehicle component therefrom.

In one configuration of the semifinished product of the invention, the semifinished product has been tailored to the vehicle component to be produced. In this way, it is possible to achieve optimal results in relation to a low weight with simultaneous retention of the usual properties of a vehicle component produced from a standard semifinished product made from steel. For example, the arrangement of the first steel material and the (at least) second steel material is chosen specifically in order to establish the properties desired in the vehicle component produced therefrom. For example, the first steel material can be provided in regions in which the properties of the first steel material are desired in the vehicle component or the properties of the (at least) second steel material are not required. Conversely, the (at least) second steel material may be provided in the regions in which the properties of the second steel material are desirable in the vehicle component.

In a further configuration of the semifinished product of the invention, the lower mass density of the first steel material is less than 7.5 g/cm³, especially less than 7.25 g/cm³, preferably less than 7.0 g/cm³. If the mass density of the first steel material is reduced to below 7.5 g/cm³, especially less than 7.25 g/cm³, preferably less than 7.0 g/cm³, it is possible to achieve a low weight of the vehicle component in the region of the first steel material and hence also overall. It has especially been found that it is possible to use even steel materials having such low densities for vehicle components without impairing the functionality of the corresponding component.

Preferably, the higher mass density of the (at least) second steel material is greater than 7.0 g/cm³, especially greater than 7.5 g/cm³. With a comparatively high mass density of the (at least) second steel material, it is possible to flexibly choose a steel material in order to provide desired properties, for instance a high strength, stiffness and/or ductility, in the vehicle component.

In a further configuration of the semifinished product of the invention, the first steel material is a density-reduced steel based on an iron-aluminum base alloy and the iron-aluminum base alloy especially includes less than 40% by weight, preferably less than 30% by weight, more preferably less than 20% by weight, of aluminum. An iron-aluminum base alloy can reduce the density of the first steel material. This can be achieved economically by including the aluminum in the alloy in the production of the first steel material. If the amount of aluminum is limited to less than 20% by weight, more preferably to less than 18% by weight, it is possible to avoid an excessive loss of strength and loss of ductility in the first steel material.

An example of an iron-aluminum base alloy which is used for the first steel material contains, as well as iron and unavoidable impurities (in % by weight):

| | | |
|---|---|---|
| | C | ≤0.15 |
| 3 ≤ | Al | ≤20 |
| | REM | ≤0.2 |
| | P | ≤0.1 |
| | S | ≤0.03 |
| | N | ≤0.1. |

REM here stands for rare earth metals, and the first steel material here may contain one or more elements from the group of the rare earth metals, each within the range specified. Optionally, it is also possible for one or more of the elements from the group of Mn, Si, Nb, Ti, Mo, Cr, Zr, V, W, Co, Ni, B, Cu, Ca to be present with the proviso (in % by weight): Mn: up to 6%, Si: up to 2%, Nb: up to 1%, Ti: up to 1%, Zr: up to 1%, V: up to 1%, W: up to 1%, Mo: up to 2%, Cr: up to 11%, Co: up to 1%, Ni: up to 2%, B: up to 0.1%, Cu: up to 3%, Ca: up to 0.015%.

In a further configuration of the semifinished product of the invention, the first steel material is a corrosion-resistant steel based on FeAlCr. In this way, the corrosion resistance of the composite can especially be improved by inclusion of Cr in the alloy, for example within a range from 2 to 11 in % by weight, and significantly lower material costs can be achieved compared to the use of rust-free materials (stainless steels, CrNi steels).

In a further configuration of the semifinished product of the invention, the first steel material is produced by introduction and/or precipitation of particles. For example, particles of ceramic, especially non-oxide ceramics, for example titanium carbide (TiC) or titanium boride (TiB₂), may be provided in the first steel material. In this way, in the vehicle component to be produced, it is possible to achieve not just a low density but additionally a high modulus of elasticity.

In a further configuration of the semifinished product of the invention, the first steel material is a metal matrix composite material. In this case, the steel may include ceramic or organic reinforcing material, for instance in the form of fibers. By means of a metal matrix composite material (MMC), it is possible not just to reduce the weight of the first steel material, but additionally also to positively affect mechanical properties, for instance elevated strength or stiffness, or thermal properties, for instance low thermal expansion.

In a further configuration of the semifinished product of the invention, the first steel material has a modulus of elasticity of more than 220 GPa. As already stated, a high modulus of elasticity can be achieved, for example, by the introduction of ceramic particles having a high modulus of elasticity or by the provision of a metal matrix composite material. This achieves a high stiffness, which is a desirable property in many vehicle components.

In a further configuration of the semifinished product of the invention, the semifinished product is a tailored blank or a tailored strip. A tailored blank is understood here to mean a sheet metal blank composed of the first steel material and the (at least) second steel material. The first and second steel materials are thus provided alongside one another in different regions over the area of the semifinished product. The region having the first and the (at least) second steel material may also have different sheet thicknesses. The steel materials are preferably bonded by means of a welding operation, for instance in the form of a tailored welded blank. A tailored strip is understood to mean that the semifinished product, by contrast with the tailored blank, is additionally provided in strip form. A semifinished product prefabricated as a tailored blank or tailored strip is subsequently cut if required and formed, for example, by thermoforming to give the desired vehicle component. In the case of production of vehicle components, the use of semifinished products of this kind is advantageous especially in the case of structural components, which frequently have to fulfill different demands in different regions.

In a further configuration of the semifinished product of the invention, the semifinished product is a multilayer composite. By contrast with a tailored blank or tailored strip, the first steel material and the (at least) second steel material are not arranged alongside one another over the area here, but are arranged one on top of another in layers. In this way, it is possible to combine the advantageous properties of the first steel material and the (at least) second steel material with one another in the same region. This is advantageous in the field of vehicle components not just in the case of structure components but also in the case of bodyshell applications or chassis applications. A multilayer composite is understood to mean that at least two layers are provided. Preferably, however, at least or exactly three layers are provided. The layer composite here is preferably produced by means of hot rolling or hot cladding. Production by means of a casting method is likewise conceivable.

Formation of the semifinished product as a tailored blank or strip and formation as a layer composite are not mutually exclusive, but can also be combined with one another. For instance, it is likewise conceivable to provide a tailored blank or strip constructed like the layer composite described in one or more regions.

In a further configuration of the semifinished product of the invention, the layer composite has a core layer composed of the first steel material and at least one outer layer composed of the second steel material. More preferably, the layer composite here has an outer layer of the second steel material on either side of the core layer of the first steel material. The light core layer and, for example, outer layers having high strength can achieve a high strength and stiffness combined with low weight. The outer layers may likewise enable good surface protection combined with nevertheless low weight. The use of further layers is also conceivable and is not limited to three layers.

In a further configuration of the semifinished product of the invention, the layer composite has a core layer composed of the second steel material and at least one outer layer composed of the first steel material. More preferably, the layer composite here has an outer layer of the first steel material on either side of the core layer of the second steel material. In this case, at low weight, it is possible to achieve, for example, a high ductility coupled with moderate strength. In this way too, it is advantageously possible to achieve a vehicle component with high strength and simultaneously high formability. In this case too, the outer layers can enable good surface protection combined with nevertheless low weight. Especially when the outer layers have a high aluminum content (based on FeAl or FeAlCr), good corrosion properties can be achieved in the components to be produced.

In a further configuration of the semifinished product of the invention, the (at least) second steel material is a cold- and/or hot-formable steel material. In a cold-formable steel material, cost-efficient production of the vehicle component is possible. If, by contrast, a hot-formable steel material is used, it is generally possible to achieve more complex geometries with simultaneously high hardness through hot forming and/or press hardening. In this respect, it is advantageous when the semifinished product is at least partially press-hardenable.

In a further configuration of the semifinished product of the invention, the vehicle component is
a structure component, for example a pillar, especially an A, B, C or D pillar, a beam, especially a transverse beam or a longitudinal beam,
a bodyshell component, for example an engine hood, a roof or a door, or
a chassis component, for example a transverse link or a crossmember,
   or a part thereof.

It has been found that the semifinished products described are especially usable advantageously for structural components, but also for bodyshell and chassis components, and enable a reduction in weight. In that case, the semifinished product, in relation to the geometry (especially size and thickness) and the arrangement of the materials, is tailored to the vehicle component to be produced in the particular case and the desired properties.

In a second teaching of the present invention, the object stated at the outset is also achieved by a process of the generic type, comprising the steps of:
providing a first steel material and at least one second steel material, where the first steel material has a lower mass density and the second steel material has a higher mass density and the ratio of the lower mass density of the first steel material to the higher mass density of the second steel material is not more than 0.95,
bonding the steel materials to one another in a form-fitting, force-fitting and/or cohesive manner to form a semifinished product, especially a semifinished product of the invention, and
forming the semifinished product to give a vehicle component.

The process of the invention thus makes use of the fact that the first steel material having the lower mass density can reduce the weight of the vehicle component produced from the semifinished product. At the same time, however, the (at least) second steel material can very substantially maintain the known advantageous properties of the vehicle component. Advantageously, the production steps for producing the vehicle component from the semifinished product can remain virtually the same, since the semifinished product can be handled and formed as before. More particularly, it has been found that it is possible to avoid geometric changes in stiffness that would lead to extra weight. These advantages are manifested especially in the production of vehicle components.

The process of the invention may further comprise the step of: coiling the semifinished product. Especially in the case of production of tailored strips or composite materials, the semifinished product can first be coiled in order, for example, to be stored, transported and/or sent to a heat treatment. Subsequently, the semifinished product can be uncoiled and, for instance, after a cutting-to-size operation, subjected to the forming operation.

The forming comprises, for example, a deep drawing operation. The forming may especially comprise hot forming and press hardening (direct hot forming) or initial cold forming with subsequent press hardening (indirect hot forming). This means that the semifinished product, or the component in a form close to the final geometry, is heated to or above the austenitization temperature and then cooled down (in regions) in the forming and hardening mold or in the hardening mold.

The step of providing the first and/or the at least second steel material may especially also comprise the step of producing the steel material. It is possible here, for example, in the production of the first steel material, as already described, to include aluminum and/or further alloy elements in the alloy or to introduce/precipitate particles in order to achieve the reduction in density.

For further advantageous configurations of the process of the invention, reference is made to the remarks relating to the semifinished product described. The configurations described therein shall likewise be applicable to the process.

In a third teaching of the present invention, the object stated at the outset is also achieved by the use of a semifinished product of the invention for production of a vehicle component. It has been found that the semifinished products described are of particularly good suitability for production of vehicle components. The semifinished products enable the production of vehicle components having low weight combined with properties simultaneously tailored to the vehicle component, for example high strength, high stiffness, high ductility and/or good surface protection.

In a fourth teaching of the present invention, the object stated at the outset is also achieved by a vehicle component produced from a semifinished product of the invention, especially by a process of the invention. As already stated, the vehicle components of the invention have a low weight combined with properties simultaneously tailored to the vehicle component.

In relation to further advantageous configurations of the use of the invention and of the vehicle component of the invention, reference is made to the remarks relating to the semifinished product and to the process.

The invention is to be elucidated hereinafter with reference to various working examples in connection with the drawing. The drawing shows, in

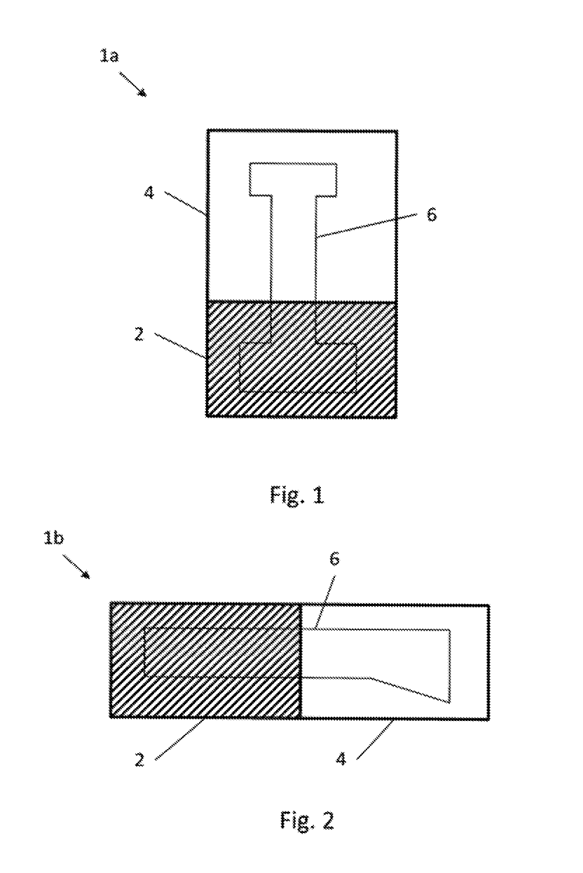

FIGS. 1, 2 top views of a first and second working example of semifinished products of the invention, each in the form of a tailored blank;

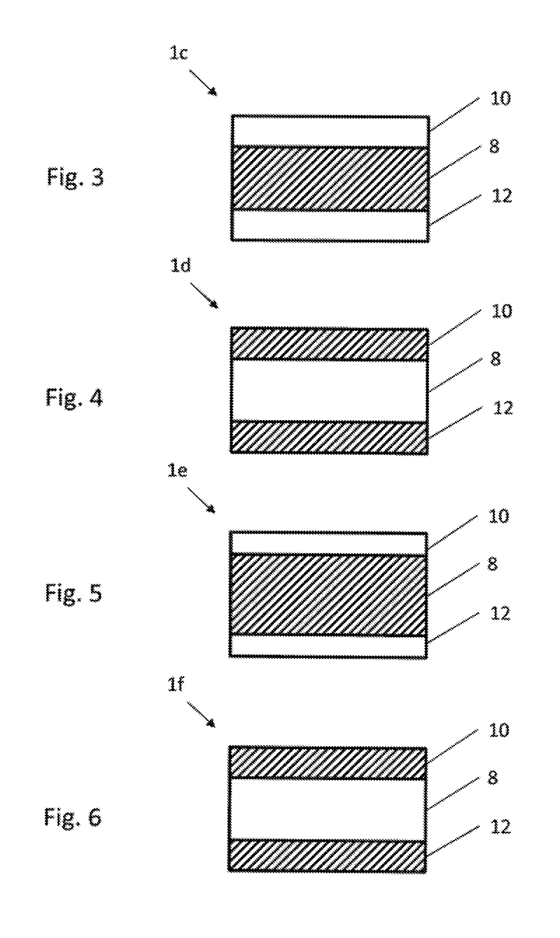

FIGS. 3-6 cross-sectional views of a third to sixth working example of semifinished products of the invention, each in the form of a multilayer composite; and

FIG. 7 a perspective schematic view of a vehicle chassis with different vehicle components.

FIG. 1 shows a first working example of a semifinished product of the invention in the form of a tailored blank 1a. The tailored blank is suitable here for production of a vehicle component. The vehicle component here is a B pillar of a motor vehicle. For this purpose, the tailored blank comprises a first region 2 composed of a first steel material and a second region 4 composed of a second steel material. The two steel materials in this case are cohesively bonded to one another by welding (for example laser welding).

FIG. 1 additionally shows, in schematic form, the region 6 from which the B pillar is produced by forming. The region 6 is cut out of the tailored blank, for example by a cutting-to-size operation. As can be seen, the lower portion of the B pillar is in the first region 2 composed of the first steel material and the upper portion of the B pillar is in the second region 4 composed of the second steel material.

The first steel material here has a lower mass density compared to the second steel material, while the second steel material has a higher mass density compared to the first steel material. The ratio of the lower mass density of the first steel material to the higher mass density of the second steel material here is not more than 0.95.

The lower mass density of the first steel material in the first region 2 results from the fact that it is a density-reduced steel based on an iron-aluminum base alloy. However, it is likewise conceivable in principle that the first steel material is produced by the introduction and/or precipitation of particles. For this purpose, for example, ceramic particles are introduced, by means of which it is especially also possible to form a metal matrix composite material as the first steel material.

The second steel material in the second region 4 consists in this case of a manganese-boron steel having a tensile strength of at least 1500 MPa in the use state, in this example in the hardened state. The alloy constituents in % by weight of the second steel material are preferably limited as follows:

| | |
|---|---|
| C | ≤0.5 |
| Si | ≤0.7 |
| Mn | ≤2.5 |
| P | ≤0.025 |
| S | ≤0.01 |
| Al | ≥0.015 |
| Ti | ≤0.05 |
| Cr + Mo | ≤1.0 |
| B | ≤0.05, |

the balance being iron and unavoidable impurities.

As a result, it is possible to provide a B pillar with which, by comparison with B pillars from the prior art, in the region of the foot of the pillar which is formed from the first region 2 comprising the density-reduced steel material, it is possible to save 10% to 20% of the weight, which can account for up to 10% of the total B pillar weight. By means of controlled processing, the first region 2 can be cold- or hot-formed.

FIG. 2 shows a second working example of a semifinished product 1b in the form of a tailored blank. By contrast with FIG. 1, the semifinished product 1b here is tailored for production of a vehicle component in the form of a front longitudinal beam which is formed from the region 6. The semifinished product again has, in the first region 2, a first steel material as described with lower density than the second steel material in the second region 4. By contrast with FIG. 1, the second steel material, however, is a dual-phase steel. The alloy constituents in % by weight of the second steel material are preferably limited as follows:

| | |
|---|---|
| C | ≤0.23 |
| Si | ≤0.8 |
| Mn | ≤2.5 |
| P | ≤0.08 |
| S | ≤0.015 |
| Al | ≤2.0 |
| Ti + Nb | ≤0.15 |
| Cr + Mo | ≤1.0 |
| B | ≤0.005 |
| V | ≤0.2, |

the balance being iron and unavoidable impurities.

In the case of a front longitudinal beam, both high demands are made on strength and energy absorption, since this has a positive effect on crash performance, and high demands are made on stiffness, since this enables, for example, optimal attachment to the engine. The semifinished product 1b shown in FIG. 2 is able to meet these two demands in an optimal manner and, at the same time, it is possible to unlock further lightweight construction potential.

FIG. 3 shows a third working example of a semifinished product 1c of the invention in the form of a multilayer composite. The layer composite has a three-layer construction and has a core layer 8 and two outer layers 10, 12. The core layer consists of a first density-reduced steel material as described. The outer layers 10, 12 in this case consist of the second steel material in the form of a manganese-boron steel as described with a tensile strength of at least 1500 MPa in the use state (hardened state). In this case, the outer layers 10, 12 have a higher strength than the core layer 8. This construction gives high strength and stiffness combined with low weight. The layer composite can especially be formed by hot forming to give a vehicle component.

FIG. 4 shows a fourth working example of a semifinished product 1d of the invention, likewise in the form of a multilayer composite. The layer composite again has a three-layer construction and has a core layer 8 and two outer layers 10, 12. By contrast with the third working example, in this case, the outer layers 10, 12 consist of a first density-reduced first steel material as described and the core layer 8 consists of a second steel material in the form of a manganese-boron steel as described with a tensile strength of at least 1500 MPa in the use state (hardened state). In this case, the core layer 8 has a higher strength than the outer layers 10, 12. This construction gives high ductility combined with moderate strength and low weight. Moreover, the outer layers serve for surface protection, especially when the aluminum content is relatively high (FeAl, FeAlCr base). The layer composite may especially be formed by hot forming to give a vehicle component.

FIG. 5 shows a fifth working example of a semifinished product 1e of the invention, likewise in the form of a multilayer composite. The layer composite again has a three-layer construction and has a core layer 8 and two outer layers 10, 12. Similarly to the third working example, the core layer 8 consists here of a first density-reduced steel material as described. The outer layers 10, 12 in this case consist of the second steel material, which here is a very ductile deep-drawing steel having a tensile strength of about 270 to 350 MPa and an elongation at break A₈₀ of at least 38%. The alloy constituents in % by weight of the second steel material are preferably limited as follows:

| | |
|---|---|
| C | ≤0.08 |
| Mn | ≤0.4 |
| P | ≤0.030 |
| S | ≤0.030, |

the balance being iron and unavoidable impurities.

A semifinished product made from a layer composite of this kind is especially suitable for vehicle components in the field of bodyshell applications (for instance engine hoods, roofs or doors), since this combines a low weight coupled with high formability with good surface protection. The layer composite can be formed here by cold forming to give a vehicle component.

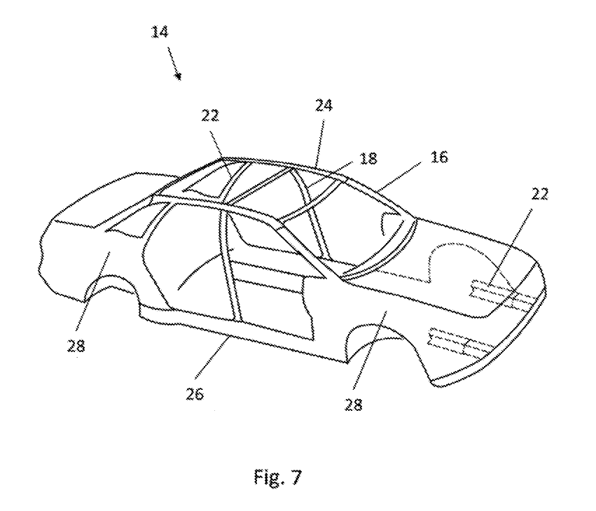

FIG. 6 shows a sixth working example of a semifinished product 1f of the invention, likewise in the form of a multilayer composite. The layer composite again has a three-layer construction and has a core layer 8 and two outer layers 10, 12. Similarly to the fourth working example, the outer layers 10, 12 here consist of a first density-reduced steel material as described, preferably based on FeAl or FeAlCr. The core layer 8 consists of the second steel material, but this, in this example, is a complex phase steel having a tensile strength of at least 750 MPa. The alloy constituents in % by weight of the second steel material are preferably limited as follows:

| | |
|---|---|
| C | ≤0.23 |
| Si | ≤0.8 |
| Mn | ≤2.20 |
| P | ≤0.080 |
| S | ≤0.015 |
| Al | ≤2.00 |
| Ti + Nb | ≤0.15 |
| Cr + Mo | ≤1.20 |
| B | ≤0.005 |
| V | ≤0.2, |

the balance being iron and unavoidable impurities.

A semifinished product composed of a layer composite of this kind is especially suitable for production of vehicle components in the region of chassis applications (for instance for transverse links or crossmembers), since this combines high strength and formability with improved surface protection. The layer composite may especially be formed by cold forming to give a vehicle component.

FIG. 7, finally, shows a perspective schematic view of a vehicle chassis 14 with different vehicle components which can be produced by way of example with the semifinished product and process described. Thus, FIG. 7 shows, by way of example, A pillars 16, B pillars 18, C pillars 20, front longitudinal beams with crash boxes 22, a roof frame 24, door sills 26 and fenders 28 as vehicle components.

The vehicle components of the invention are not restricted to passenger-carrying motor vehicles, but to all motor-driven vehicles, for example utility vehicles, but also for engineless vehicles, for example trailers that are pulled by tractor trucks.

1.-17. (canceled)

18. A semifinished product for production of a vehicle component, the semifinished product comprising:
a first steel material with a lower mass density; and
a second steel material with a higher mass density, wherein the first and second steel materials are bonded to one another in at least one of a form-fitting manner, a force-fitting manner, or a cohesive manner,
wherein a ratio of the lower mass density of the first steel material to the higher mass density of the second steel material is at most 0.95.

19. The semifinished product of claim 18 tailored to the vehicle component to be produced.

20. The semifinished product of claim 18 wherein the lower mass density of the first steel material is less than 7.5 g/cm³.

21. The semifinished product of claim 18 wherein the first steel material is a density-reduced steel based on an iron-aluminum base alloy, wherein the iron-aluminum base alloy includes less than 30% by weight of aluminum.

22. The semifinished product of claim 21 wherein the first steel material is a corrosion-resistant steel based on FeAlCr.

23. The semifinished product of claim 18 wherein the first steel material is a metal matrix composite material.

24. The semifinished product of claim 18 wherein the first steel material comprises at least one of introduced particles or precipitated particles.

25. The semifinished product of claim 24 wherein the first steel material has a modulus of elasticity of more than 220 GPa.

26. The semifinished product of claim 18 configured as a tailored blank or a tailored strip.

27. The semifinished product of claim 18 configured as a multilayer composite.

28. The semifinished product of claim 27 wherein the multilayer composite comprises:
a core layer comprised of the first steel material; and
an outer layer comprised of the second steel material.

29. The semifinished product of claim 27 wherein the multilayer composite comprises:
a core layer comprised of the second steel material; and
an outer layer comprised of the first steel material.

30. The semifinished product of claim 18 wherein the second steel material is at least one of a cold-formable steel material or a hot-formable steel material.

31. The semifinished product of claim 18 wherein the vehicle component is
a pillar or a beam;
a bodyshell component;
a chassis component; or
a part thereof.

32. A process for producing a vehicle component, the process comprising:
providing a first steel material with a lower mass density and a second steel material with a higher mass density, wherein a ratio of the lower mass density of the first steel material to the higher mass density of the second steel material is at most 0.95;
binding the first and second steel materials to one another in at least one of a form-fitting manner, a force-fitting manner, or a cohesive manner to form a semifinished product; and
forming the semifinished product into the vehicle component.

33. A vehicle component produced from a semifinished product, wherein the semifinished product comprises:
a first steel material with a lower mass density; and
a second steel material with a higher mass density, wherein the first and second steel materials are bonded to one another in at least one of a form-fitting manner, a force-fitting manner, or a cohesive manner,
wherein a ratio of the lower mass density of the first steel material to the higher mass density of the second steel material is at most 0.95.
